(19) United States
(12) Patent Application Publication
(10) Pub. No.: US 2019/0050164 A1
(43) Pub. Date: Feb. 14, 2019

(54) SYSTEM, METHOD , AND COMPUTER PROGRAM PRODUCT FOR SECURELY DELIVERING CONTENT BETWEEN STORAGE MEDIUMS

(71) Applicant: RADICAL APP LLP, Los Angeles, CA (US)

(72) Inventors: Rohit KOTIAN, Los Angeles, CA (US); Ryan Ozonian, Venice, CA (US); Igor Shpitalnik, Valencia, CA (US)

(21) Appl. No.: 16/066,291

(22) PCT Filed: Dec. 27, 2016
(86) PCT No.: PCT/US16/68752

§ 371 Date: Jun. 26, 2018

Related U.S. Application Data
(60) Provisional application No. 62/272,185, filed on Dec. 29, 2015.

(51) Int. Cl. G06F 3/06

(52) U.S. Cl. CPC G06F 3/0652; G06F 3/0644; G06F 3/0679; G06F 3/067; G06F 3/0604; G06F 3/0665

(57) ABSTRACT

A computer program implemented method for securely transferring content sent between clients using a storage media and a computer processor is provided. The method describes receiving the content on a server array from a first node, storing the content on volatile memory on logical memory store, the logical memory store comprising at least two of the servers of the server array, creating a unique identification for the content, allowing retrieval of the content based on predetermined business logic, the unique identification or both, and resetting the volatile memory on the plurality of servers at a predetermined time after retrieval to permanently erase the content. A system for securely transferring content sent between clients using a storage media and a computer processor is also provided.

### CROSS-REFERENCE TO RELATED APPLICATION

The present utility patent application claims the priority benefit of the U.S. provisional application for patent Ser. No. 62/272,185 filed on Dec. 29, 2015, A System and Method for Content Delivery.

### FIELD OF THE INVENTION

The present invention relates to content delivery and data security. More particularly, the invention relates to a system, method and computer program product for securely delivering, viewing, or transferring content between storage mediums, and permanently erasing or wiping the content from the storage mediums in an unrecoverable manner.

### BACKGROUND OF THE INVENTION

According to a study by the Poneman Institute, a staggering 43% of companies have experienced a data breach in the past year, costing a mean of $7.6 million dollars per company studied, the highest of which lost upwards of $65 million dollars due to the data breach.

Most of the companies are experiencing a large percentage of failures in data security, even when they have the most up to date security intelligence systems. This is due to the requirements of physical storage media, such as non-volatile secondary storage primarily used for medium or long-term storage (e.g., hard drives).

The problems that arise based on these secondary storage types are two-fold. Since the information is stored until erased, criminals can acquire relatively old data that is housed on the drive due to the difficulty in wiping these storage mediums completely clean, and also, in such a manner so that even forensic analysts cannot recover the data. The latter can be particularly troublesome in the context of litigation, when files that were supposed to be deleted are more easily accessible than the user had planned.

In most organizations that require data security, there are ascending levels of information protection required, depending upon the sensitivity of the information at hand. As an example, instant messages from one low-level employee to another will not require the same level security as CEO emails or the formula to a particular best-selling soda for example. In the data storage universe, there is typically a tiered cost structure based on the sensitivity and level of security required by the client.

Current devices and methods used for storage utilize volatile storage for less sensitive information (e.g., the instant message chats) including primary storage means such as cache, main memory and flash. However, these primary storage means are costly and the fastest form of storage, not easily or inexpensively scalable, (e.g., usually very small, and managed by the operating system), the contents of main memory are usually lost in a power failure or crash, and in the case of flash memory (EEPROM) writing data is more complicated, and to overwrite what has been written, one has to first erase the entire bank of the memory—which may support only a limited number of erase cycles. As such, current methods of data storage using volatile memory are risky due to the possibility of total data loss, inefficient based on cost and not easily scalable.

Past ad hoc approaches for wiping non-volatile memory discs clean are tenuous, time consuming, and most importantly, ineffective. For example, in mechanical hard drives, files a user deletes can be recovered by forensic investigators because when the user deletes a file from the drive, the drive simply marks the file's data as deleted. Until it's overwritten in the future, people can scan the drive and recover the marked-as-deleted data. And then, even when it is overwritten, it may not be overwritten in its entirety.

Other approaches to this problem utilize solid-state drives (SSDs) and a feature called TRIM, in which when a user deletes a file, the operating system informs the drive that the file was deleted. The drive then erases the file's data from its memory cells. However, SSDs cost approximately twice as much as their non-volatile cousins, making scalability for SSDs costly.

While some critical data must be stored on hard drives, other less critical data can be stored in less expensive means, especially the data that is not required long-term, but only required to reach a recipient once, and then disappear or vanish forever with no ability to be forensically retrieved.

As an example, in the context of short messaging systems (SMS) and push notifications, it may be desirable for these messages, once received and read, to vanish forever.

However, with trillions of text messages sent each year, it is exceedingly difficult to forego non-volatile memory, due to the cost and other problems associated with volatile memory, above. However, it is extremely important to some users that their text messages not be recoverable, as they can be used out of context by overzealous attorneys during litigation.

Accordingly, there is a need for a system and method that stores information for short periods, then fully deletes and wipes this information from the storage medium, while being easily scalable, and inexpensive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram illustrating an exemplary embodiment of the content delivery platform system according to another embodiment of the present invention;

FIG. 2 is a block diagram illustrating an exemplary embodiment of the content delivery platform system according to another embodiment of the present invention;

FIG. 3 is a block diagram illustrating an exemplary embodiment of the content delivery platform system according to another embodiment of the present invention;

FIG. 4 is a flowchart illustrating an exemplary process for securely transferring and wiping the content according to an embodiment of the present invention;

FIG. 5 is a flowchart illustrating an exemplary process for securely transferring and wiping the content according to an embodiment of the present invention;

FIG. 6 is a flowchart illustrating an exemplary process for securely transferring and wiping the content from a according to an embodiment of the present invention;

FIG. 7 is a flowchart illustrating an exemplary process for securely transferring and wiping the content according to an embodiment of the present invention;

Unless otherwise indicated, illustrations in the figures are not necessarily drawn to scale.

### SUMMARY OF THE INVENTION

To achieve the forgoing and other aspects and in accordance with the purpose of the invention, a method, system and computer program product for increasing user value is presented.

An objective of the invention is to provide a distributed in-memory content delivery platform for sharing a plurality of content between nodes (e.g. clients) over a communication network.

An objective of the invention is to provide a system and method for content sharing using in-memory design such that shared content cannot be recovered once purged from the system.

An objective of the invention is to make applications such as messaging or digital file sharing fundamentally safer for their users.

An objective of the invention is to provide a distributed and secure solution for content sharing between the users.

An objective of the invention is to delete, permanently and without the chance for recovery, certain data from the distributed in-memory store based on the content deletion request or expiration of the time period, and other business logic.

An objective of the invention is to securely eliminate unnecessary data to avoid data storage overflow.

An objective of the invention is to provide greater speed of data flow between a plurality of nodes.

An objective of the invention is to provide enhanced reliability and redundancy of content data transfer, while at the same time ensuring high data flow speed.

In embodiments of the present invention, a computer program implemented method for securely transferring content sent between clients using a storage media and a computer processor is provided. The method comprises receiving the content on a server array from a first node, storing the content on volatile memory on cluster logical memory store, the cluster logical memory store comprising at least two of the servers of the server array; creating a unique identification for the content; allowing retrieval of the content based on predetermined logic, the identification or both, and resetting the volatile memory on the plurality of servers at a predetermined time after retrieval to permanently erase the content.

In embodiments of the present invention, a computer program implemented system for securing data sent between clients using a storage media and a computer processor is provided. The system comprises a server array capable of receiving data from a node, the server array comprising a storage medium provisioned for a cluster server memory store, memory storing instructions that when executed by at least one processor cause the system to receive the content on a server array from a first node, store the content on volatile memory on cluster logical memory store, the cluster logical memory store comprising at least two of the servers of the server array; create a unique identification for the content, allow retrieval of the content based on predetermined logic, the identification or both, and reset the volatile memory on the plurality of servers at a predetermined time after retrieval to permanently erase the content.

Other features, advantages, and aspects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed, but that all fit within the scope of the invention. Also, singular words should be read as plural and vice versa and masculine as feminine and vice versa where appropriate, and alternative embodiments do not necessarily imply that the two are mutually exclusive.

It is to be further understood that the present invention is not limited to the particular methodology, compounds, materials, manufacturing techniques, uses and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

While exemplary embodiments of the present invention will be described with reference to certain types of mobile applications, a skilled artisan will realize that embodiments of the invention are applicable to any type of data security or messaging system, or applications in which data storage space is limited.

As used herein, the terms “delivering” and “transferring” shall comprise the ability for one node to view content on a server, and vice versa. Indeed, the content does not need to be physically transferred to fall under these definitions.

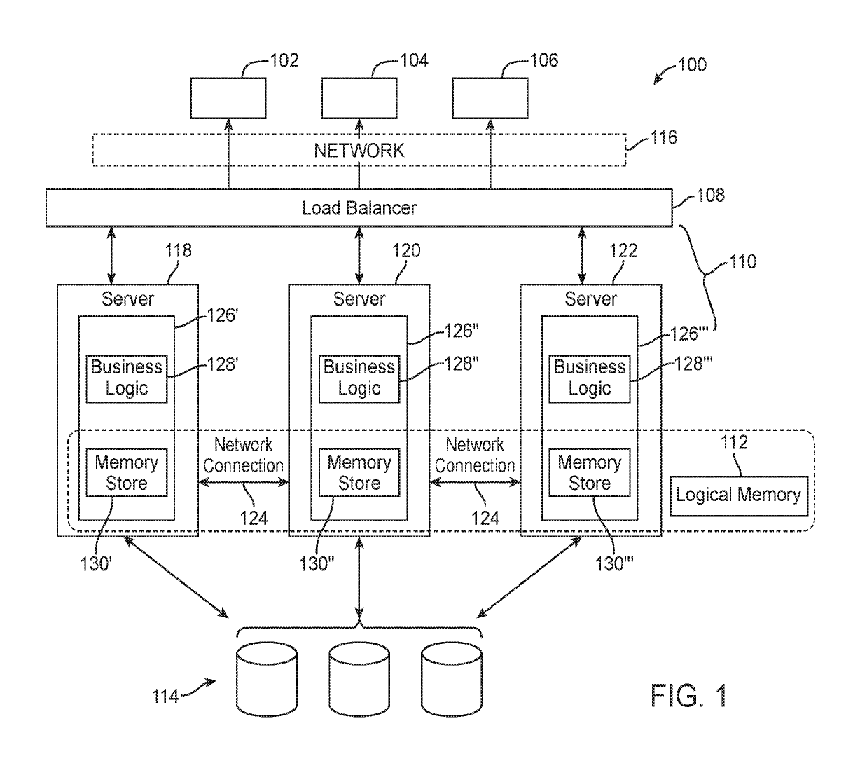

FIG. 1 is a block diagram illustrating an overview of the content delivery system 100 according to the present invention. The content delivery platform 100 comprises node 102, client 104, web host 106, load balancer 108, server array 110, memory store 112, database 114 and network 116.

As used herein, “client” and “node” are used interchangeably, with a node representing a client. The node may be client endpoints, endpoint nodes, and the like. In FIG. 1, as referenced, three nodes are shown: Node 102, client 104, and web 106 to show a few of the exemplary nodes that may be employed, generally. The nodes 102, 104 and 106 may comprise, but are not limited to, personal computers, workstations, mobile wireless devices, including dedicated wireless devices, smart phones, pagers, PDA, or other similar type of devices capable of processing instructions and receiving and transmitting data to and from other computing devices. The content residing thereon, for example, may include audio, videos, text SMS, messages, multimedia files, images, e-mails, office content, and the like.

The clients or nodes, as is known, may comprise instructions to execute executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

Server array 110, and the exemplary servers 118, 120, 122 may be referred to as servers, server farm, or hosts. The servers of the server array 110 are logically grouped together, and can be geographically dispersed, or located proximate to each other, and may be configured to communicate using a WAN, or LAN. In some embodiments, a server array 110 can include servers that execute a substantially similar type of operating system platform (e.g., WINDOWS NT, UNIX, LINUX, or MacOS, or could be a docker container within a VM on an AWS host). In other embodiments, the server array can include a first group of servers that execute a first type of operating system platform, and a second group of servers that execute a second type of operating system platform.

The server array 110 may comprise servers of different types. Exemplary servers include file servers, an application server, web servers; a proxy servers, and the like. Some embodiments include a first server 118 that receives requests from a client 102, forwards the request to a second server 120, and responds to the request generated by the client 102 with a response from the second server 120.

In the embodiment shown in FIG. 1, the servers comprise Unix servers in networked communication, as shown by arrows 124. The servers, in this embodiment, comprise virtual machines 126 (e.g., Java virtual machine (JVM)) and provides for loading, linking, and initialization.

Each of the servers 118, 120, and 122 further comprise business logic 128ⁱ⁻ⁱⁱⁱ. The business logic 128 is configured as a set of predetermined rules for data flow and data deletion requests, determine how data can be created, displayed, stored and changed. Exemplary business logic comprises to which content or data to assign an ID to, for which the servers notify the node/client/web about available content or data, the amount of time content or data is on the system before it is purged in an unrecoverable manner, which content or data entries are to be polled and in which order (e.g., interval polling based on the age of the data), to name a few. Further business logic may comprise which data is sorted and which is permanently deleted, which data receives redundancies on servers, and the like.

The array of servers 110 also comprise a cluster logical memory (CLM) store 112. As shown, the CLM store 112, more broadly, is memory virtualization, or decoupled volatile random access memory (RAM) resources from individual servers 118, 120, and 122 which aggregates those resources into a virtualized memory pool (CLM 112) available to any server in the cluster. In embodiments of the present invention, the memory pool is accessed by the operating system or applications running on top of the operating system 126 and the business logic 128. The distributed memory pool can then be utilized as a high-speed cache, a messaging layer, or a large, shared memory resource for a CPU or a GPU application. Importantly, in embodiments of the present invention, the business logic instructs for copies of content on a plurality of servers 118, 120, and 122 of the server array 110 to provide redundancies and latency in case of a unintended power down or fault so that important data is not lost when the volatile memory is wiped. Consequently, in some embodiments of the present invention, different bits of content and data will be stored on memory store 130ⁱ⁻ⁱⁱⁱ until they are reassembled for use. These memory stores 130 are also fault tolerant so as to provide redundancy (e.g., dual module redundancy) in case there is a failure of any one or more of the servers in the array of servers, which may happen for a myriad of reasons.

In this way, the server array 110 and system is further configured to persist the content and data onto memory stores 130, which may be any number of stores.

Referring still to FIG. 1, network 116 is configured to transmit data and content from nodes 102, 104 and 106 to server array 110. The network 104 may comprise one or more sub-networks, and may comprise a local-area network (LAN), or a wide area network (WAN) and the like. The network topology may differ within different embodiments, possible network topologies include: a bus network topology; a star network topology; a ring network topology; a repeater-based network topology; or a tiered-star network topology.

Load balancer 110 may be, in some embodiments, a smart load balancer, or in other embodiments, a dumb load balancer. The load balancer 110 is configured to distribute workloads from the nodes across multiple computing resources, such as used in large Internet Relay Chat networks, high-bandwidth File Transfer Protocol sites, Network News Transfer Protocol (NNTP) servers, Domain Name System (DNS) servers, and databases. Known load balancing techniques such as round-robin and DNS delegation may be employed herein.

Database 114 is non-volatile memory (e.g. hard disk memory) configured to store user profiles and other information that is considered non-sensitive, such as, but not limited to, name, age, sex, location, areas of interest, dislikes, email address, hobbies, and occupation. The database 114 is in communication with but partitioned from the server array 110, and is configured such that the data can be received on the server array 110, and associated with the content or data that resides on the memory store 112 from each of the nodes 102, 104 and 106.

The term “in-memory database,” or “IMDB,” is used herein to refer broadly and inclusively to any database management system that primarily relies on main memory, rather than a disk-based mechanism, to store and manage data, such as memory store 112. The memory can be, for example and without limitation, semiconductor memory such as random-access memory (RAM), high-speed volatile memory, or other similar type of memory or storage device. The use of a distributed in-memory database as described herein is intended to provide improved performance and scalability, and security.

In operation, content or data is sent from a first node, in this example, node 102, which may be a smartphone. The content is distributed to the server array 110 via load balancer 108, which optimizes resource use, maximizes throughput, minimize response time, and avoids overload of any single resource. When the content is received at the server array 110, it is persisted and distributed to the pool of memory stores 130ⁱ⁻ⁱⁱⁱ. As an example, content may reside on servers 118 and 120, and also 122. Further, portions of the content may reside on one or multiple servers. Due to the unique IDs generated, the servers can locate the content in whole or in part when it is ready to be consumed, viewed, or otherwise processed once pulled from memory store 112. The business logic is configured to run rules, coordinate the data, process commands, make logical decisions and evaluations, and in some embodiments, perform calculations based on received data.

The servers 112 and business logic 128 are further configured to create a unique identification that is used to identify the message and ensure it is associated with the correct and intended user.

The servers are further configured to encrypt the content or data using an encryption system, for example, a key that services to encrypt the content and ensure the content is only consumed by the intended node. Exemplary embodiments of encryption systems comprise public-key cryptography that utilizes asymmetric key algorithms in addition to or in place of traditional symmetric key algorithms, but other keys and encryption system may be used as well.

In operation, and still with reference to FIG. 1, the server array 112 is configured to generate a notification and send the notification to client 106 that there is content that is ready to be viewed or consumed. Importantly, this notification relies on information received from database 114, such that the server associates the content with the proper node (e.g., web client 106). Optionally, the content may be requested by web client 106 for utilization. In other embodiments, it is automatically sent once the node is confirmed as the appropriate receipting. Should the request be authorized by the ID/key and business logic 128, the content is viewable on the client 106. Once the content is utilized and consumed by client 106, the business logic 128 may execute a resetting step. The resetting step is configured to permanently delete the content or data from the volatile memory across the cluster, such that even forensics are unable to retrieve bits or portions of it. In embodiments of the present invention, the resetting step may comprise a very brief power down, or an executed operation. Powering down the servers comprises setting the logic circuit gates to power off and powering up comprises setting the gates back to power on.

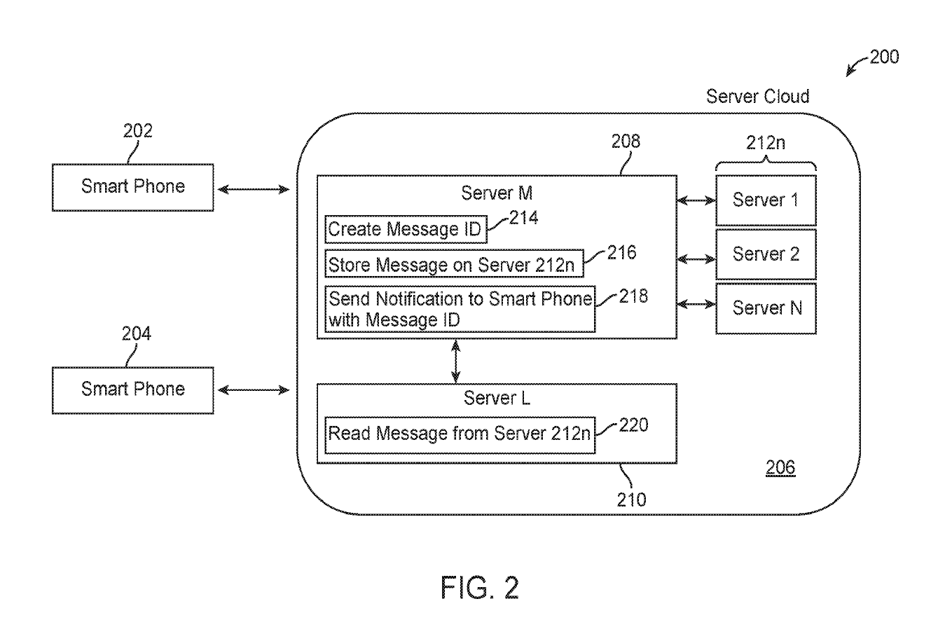

Referring now to FIG. 2, a block diagram of a secured messaging system is shown generally at 200 together with step-wise diagram inculcated therein. The content delivery system 200 comprises smartphones 202 and 204, server cloud 206 and the servers that reside therein 208, 210 and 212n.

In operation, a message is sent from the first phone 202, and resides on server 208. The server 208 creates a message ID, step 214, and stores the messages on server array 212n in a fault tolerant manner. The message is then persisted, in part or in whole, and distributed to the pool servers 212n, step 216, each of which are in communication with the other. The message resides on volatile memory in each of the servers 212n.

Business logic, which resides on servers, reviews, evaluates and coordinates the message, then ensures it is stored for retrieval at some predetermined interval. Should the message reside on the servers for over a predetermined time, a reset function may be employed to permanently erase the message as described with reference to FIG. 1.

The servers then generate a notification step 218, in this case a message letting smartphone 204 know that a message is available for viewing. Importantly, this notification relies on information received from database, the ID, and/or the encryption keys, such that the server associates the content with the proper smartphone.

The smartphone 204 can then request to view the message, and should it be authorized by the ID/key and business logic 128, the message is viewable on the smartphone 204, step 220. Once the message is viewed, after a predetermined time has passed, the servers execute a resetting step to permanently delete the message from the servers 208, 210, and 212.

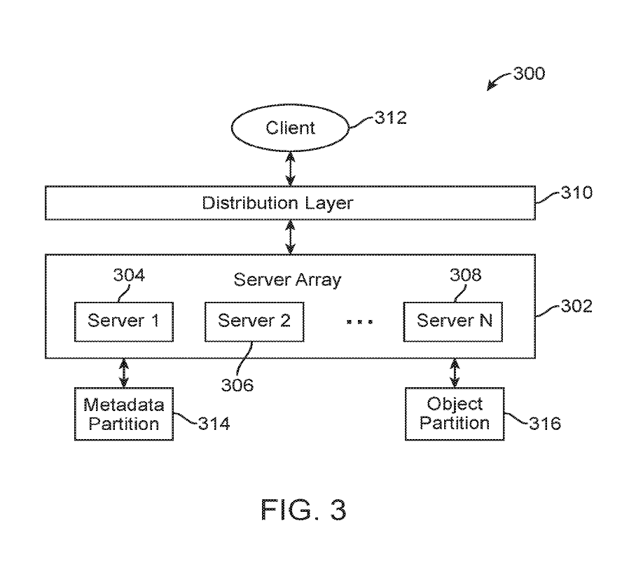

In an optional embodiment, referring now to FIG. 3, a block diagram depicting an exemplary client/server system for securely transferring data is shown generally at 300 in which management tasks (including responding to client requests and enforcing content expiration) distributed over multiple servers. Such distribution enables the invention to be scaled to a massive volume of management tasks with higher fault tolerance.

The server array 302 comprises of one or more management servers 304, 306, 308. The servers may be running on heterogeneous systems, for example, varying in processing power. Each server can in principle handle any functionality previously described, though in practice, a system administrator may improve computational cost efficiency by specializing certain servers to handle various subsets of full functionality. In preferred embodiments, all management servers synchronize their clock times with authoritative time sources.

The distribution layer 310 may be any suitable load-distribution system, including many commercially available solutions. Accordingly, the distribution layer 310 may itself comprise multiple devices cooperating to perform the functions described, so as to also support massive scale with fault tolerance.

In embodiments of the present invention, one function of the distribution layer 310, is to ensure that at least one of the servers within the server array 302 is enforcing expiration of content. In one embodiment, a plurality of management servers may contend to delete the same expired content, which has no ill effect other than redundant computation. In an alternative embodiment, the servers may cooperate. For example, each server may briefly lock the metadata of expired items that it is actively processing for deletion. Alternatively, the servers can select exclusive time slices in which they manage expiry or prioritize which expired items they act upon first, utilizing an ordinal number that is determined and received from the Distribution Layer 310 or some other well-known arbitration mechanism.

In embodiments of the present invention, the distribution layer 310 is further configured to proxy requests from clients 302. Requests originating from a Client 312 (e.g. to store, retrieve, and delete content) are sent to the distribution layer 310, which in turn selects a server from server array 302 to process the request. The selected server will in turn fulfill the request as previously described, by contacting the metadata partition 314 and object partition 316. The servers 304, 306, 308 response is then returned to the distribution layer 310 for passing back on to the client 312 that originated the request.

In selecting a management server to handle a client request, the distribution layer 310 may use a variety of methods, as is well-known to those skilled in the art, such as round-robin or a dynamic hash table. The distribution layer 310 may have a provision to exclude selecting servers that are still processing previous requests but have been marked by a system administrator as unavailable for further incoming requests. When one or more servers are configured to handle some subset of the full management functionality, the distribution layer 310 must be configured to select only from management servers that are eligible to fulfill the type of request being proxied.

The distribution layer 310 may use real-time indications of capacity available for each management server in order to avoid overloading any given server. If the distribution layer 310 observes limited capacity in the face of an increasing volume of requests, it may be able to cause deployment additional servers in the server array 302, or conversely spin down capacity when no longer needed.

The distribution layer 310 may perform any generic request and response processing functionality that could also be performed by individual management servers. For example, the distribution layer 310 may be similarly capable of logging, buffering, and enforcing timeouts on requests and responses. For client requests, the distribution layer C02 may also perform URI rewrites and other transformations, use client IP address range to restrict or limit the rate of requests, or judiciously retry server selection and proxying the client request when the initial server selected fails to fulfill the request.

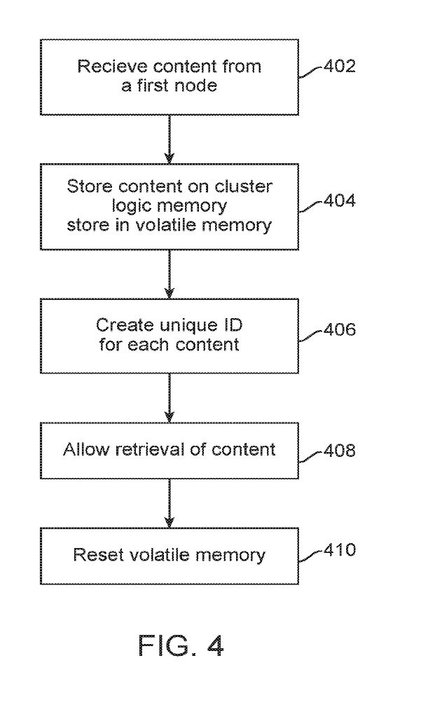

Referring now to FIG. 4, a flowchart illustrating a simplified method for securely wiping data from a server, which is shown generally at 400.

At step 402, the server array receives content from a node.

At step 404, the content is stored on volatile memory on cluster logical memory store residing on the server, the cluster logical memory store comprising at least two of the servers of the server array.

At step 406, the server creates a unique identification for the content.

At step 408, the server allows for retrieval of the content based on predetermined logic, the identification or both.

At step 410, the server resets the volatile memory on the plurality of servers at a predetermined time after retrieval of the content to permanently erase the content.

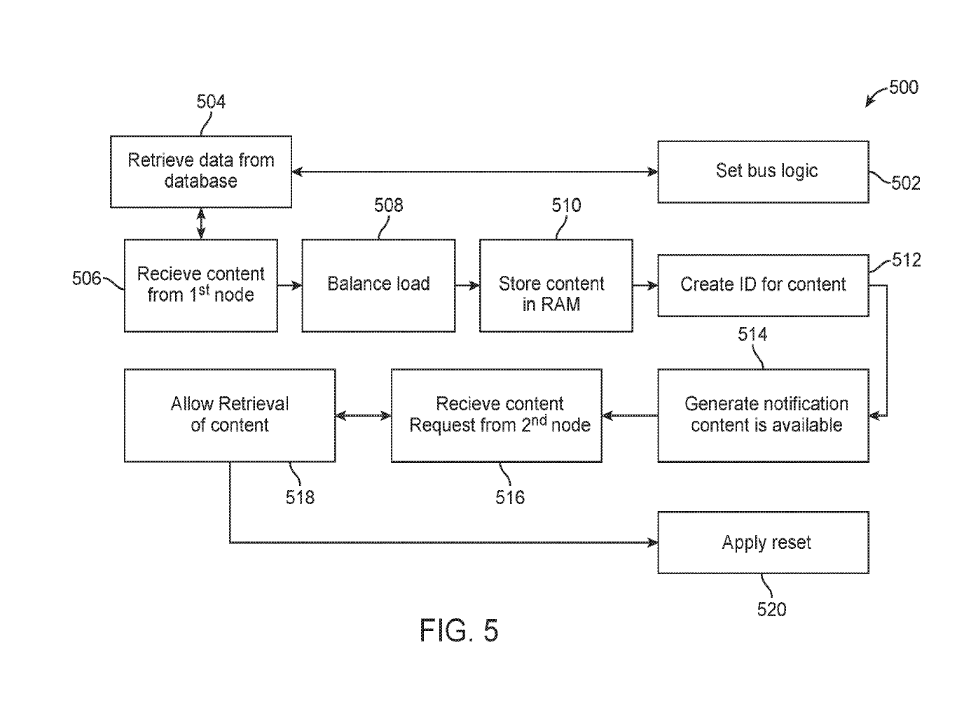

Referring now to FIG. 5 a flowchart illustrating a method for viewing and securely wiping data from a server is shown generally at 500.

Initially, at step 502, the operator, who is the manager of the platform, sets business logic, step 502 (i.e., “set bus logic”). The business logic is configured as a set of predetermined rules for data flow and data deletion requests, determine how data can be created, displayed, stored and changed. Exemplary business logic comprises to which content or data to assign an ID to, to which the server notifies the client about available content or data, the amount of time content or data is on the system before it is purged in an unrecoverable manner, which content or data entries are to be polled and in which order (e.g., interval polling based on the age of the data), to name a few. Further business logic may comprise which data is sorted and which is permanently deleted, which data receives redundancies on servers, and the like.

At step 504, the server array is configured to extract data from a non-volatile database. The data may comprise user data, for example, data that is not sensitive in nature and data that is required to be stored on a long-term basis. The server is configured to associate this data with nodes based on unique keys and IDs.

At step 506, the server array receives content from a first node. The date may comprise content, or data, the latter being small subsets of content.

At step 508, the load is distributed to the servers in the array by a load balancer.

At step 510, the content is stored in RAM, in a cluster logical memory store, and is persisted throughout the array.

At step 512, the server array creates a unique ID or key for the content, which is associated with the node it is to be retrieved by, the node where it came from, or both.

At steps 514/516, the server array generates a notification or receives a request to view the content from a second node, and the server array receives a content request, or generates a content notification allowing retrieval of the content.

At step 518 the second node receives the content.

At step 520, a reset is applied to permanently erase the content from the RAM.

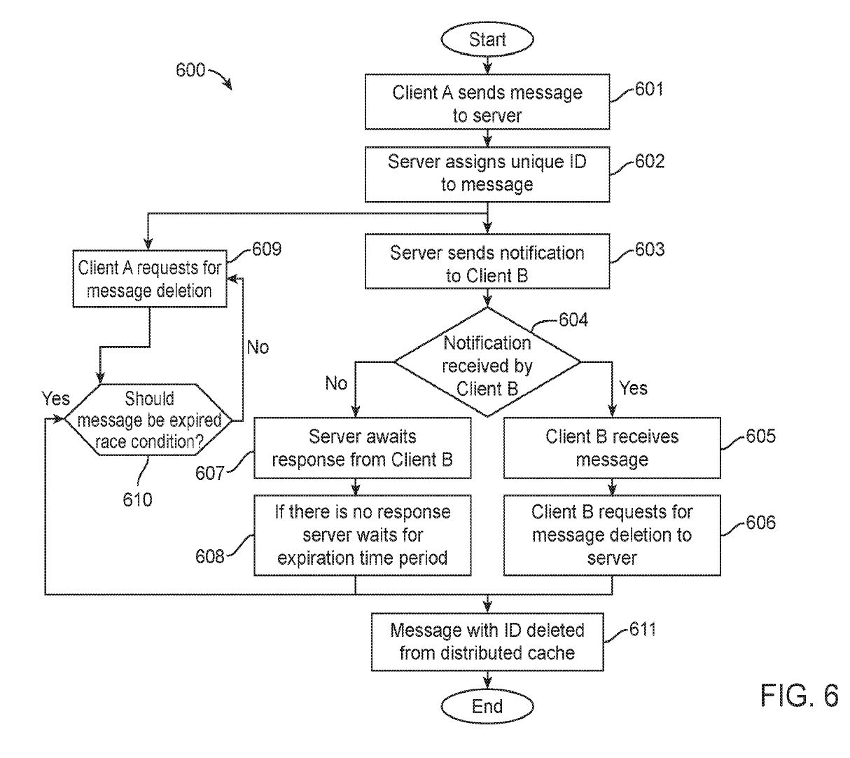

Referring now to FIG. 6 a flowchart illustrating a method for sending content from a client to another client and securely wiping data from a server is shown generally at 600. In this optional embodiment, the “distributed cache” referred to may be viewed as analogous to the memory store of FIG. 1, for purposes of these upcoming FIGS. In the example implementation shown in FIG. 6, which begins at Step 601, Client A sends content to the server which is to be delivered to client B.

In step 602, a unique ID is assigned to the content by the server. In step 603, the server notifies the Client B about the content by sending the unique ID to the Client B and awaits response from the Client B.

At decision point 604, if Client B receives the notification about the content, the method continues to step 605 in which the message is received by the Client B. At step 606, the Client B requests the server using the unique ID that the message should be deleted from the distributed cache. The server receives the request and deletes the data from distributed cache using the unique ID in an untraceable and unrecoverable manner in step 611.

At decision point 604, if Client B does not receive the notification about the content, the method continues to step 607 in which the server awaits response from the Client B. If the server does not get any response from the Client B, the method proceeds to step 608.

At step 608, the message is examined at preferably regular intervals to determine if the message should be deleted based on the expiration time associated with the message which is defined by the server or one of the clients. If the expiration time has passed, the message is deleted in an untraceable and unrecoverable way from the distributed cache as in step 611.

At step 609, Client A can also request the server for the deletion of the message. At block 610, the message is examined preferably at regular intervals to determine if the expiration time has passed or not defined by the server or one of the clients. If the expiration time has passed, the method proceeds to step 611 and the message with ID is deleted from distributed cache in an untraceable and unrecoverable manner.

The content or message once consumed can be deleted from the distributed cache in variety of ways. For example, if distributed cache is implemented in Random Access Memory (RAM), the stored content may not be refreshed and allowed to discharge on its own or else power can be cut off from particular transistors or capacitors storing the said content. Other ways for deleting the content from cache or RAMs are also within the scope of the invention that allows for deletion of content in an unrecoverable manner.

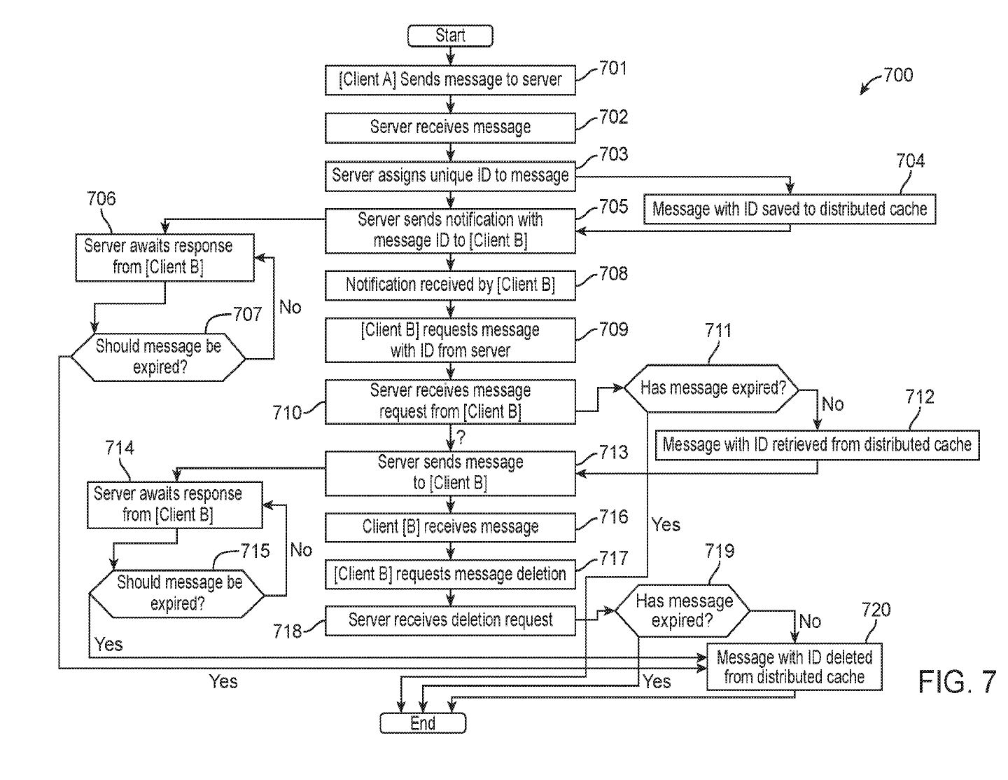

FIG. 7 is a flowchart, illustrating a detailed view in accordance with an example of process steps associated with the present invention, and in accordance with communication between clients, server and distributed cache.

In the present embodiment of this invention as shown in FIG. 7, which begins at step 701, Client A sends content to the server which is to be delivered to client B. In step 702 server receives the message sent by Client A and in step 703 a unique ID is assigned to the message by the server sent by Client A. The message with ID which was assigned by the server is saved in distributed cache in step 704. The term distributed cache or “in-memory database,” or “IMDB,” is used herein to refer broadly and inclusively to any database management system that primarily relies on main memory, rather than a disk-based mechanism, to store and manage data. The memory can be, for example and without limitation, a semiconductor memory such as random-access memory (RAM), high-speed volatile memory, or other similar type of memory or storage device. The use of a distributed In-memory database as described herein is intended to provide improved performance and scalability.

From steps 701 to 704, the severs are also utilized for receiving content from Client A and assigning unique ID to the content. In step 705, the server sends the notification to the Client B about the content sent by the Client A, by sending unique ID to the Client B and awaits response from the recipient client as in step 706. Here the recipient client refers to Client B. From steps 705 to 706 the server notifies the Client B about the message and waiting for the response from the Client B.

At block 707, the message is examined preferably at regular intervals to determine if there is any response from the Client B. If the Client B has not responded to the notification of the unique ID, then the message is deleted based on the expiration time associated with the message which is defined by the server or one of the clients. If the expiration time has passed, the message with ID is deleted in an untraceable and unrecoverable way from the distributed cache as in step 720.

In step 708, Client B receives the notification sent by the server or notification module and places a request to the server to send him the message along with ID as in step 709. The server receives the message request sent to him by the Client B at step 710 and processes the request placed by the Client B by examining the expiration time that is associated with the message as in step 711. If the expiration time has not passed, the message with ID is retrieved from the distributed cache as in step 712 and the method continues to step 713.

In step 713, the server sends the message to Client B and awaits response from the recipient client as in step 714. At block 715, the message is examined preferably at regular intervals to determine if there is any response from the Client B. If the expiration time has passed, the method proceeds to step 720 and the message with ID is deleted from distributed cache in an untraceable and unrecoverable manner.

From steps 709 to 714, the processing module as explained in FIG. 1a can be utilized by the server for receiving the content request from the Client B and can retrieve the content from the distributed cache based on the unique ID and sends the content to Client B with unique ID.

At step 716, the Client B receives the message from the server sent by the Client A. After receiving the message, Client B may request for the deletion of the message from the server sent to him by Client A in step 717. The server receives the message deletion request at step 718 and examines the message that it has expired or not based on the expiration time associated with the message as in step 719. If the expiration time has not passed, the method proceeds to step 720 and the message with ID is deleted from distributed cache in an untraceable and unrecoverable manner.

From steps 717 to 720, the content deletion module as explained in FIG. 1a can be utilized by the server for receiving the request from either of the clients or calculating the remaining expiration time associated with the stored message and deleting the message with unique ID from the distributed cache. While the various operations of the deletion method are described in reference to the database system, other devices or systems that can delete the data from RAM in an unrecoverable and untraceable manner may also be employed to perform the deletion.

In an embodiment of the present invention the message with ID which was assigned by the server is saved in distributed cache that primarily relies on random-access memory (RAM). There exists multiple ways to delete the content stored on RAM in unrecoverable manner. For example, the distributed cache or “in-memory database” is not refreshed and starts discharging on its own for deleting the content. The other operations of deletion can include power cut off from the particular transistors or capacitors that are embedded on the integrated circuit (IC) or RAM. Other ways for deleting the content from cache or RAMs are also within the scope of the invention that allows for deletion of content in unrecoverable manner.

Without limitation, the system and methods described herein can be utilized on platforms for large data sets are stored, but do not or should not be repentantly saved.

As an example, sensor data from various intelligent platforms, whether it be large manufacturing and assembly lines or oil pipelines, are capable of taking many millions of measurements each day. Many times, only a small percentage of these measurements are valuable, and thus storing them all on non-volatile memory is expensive and inefficient. The present system is configured to sort measurements in its persisted data stores and associate the relevant measurements using this business logic to the cull the data set and send only relevant data to the non-volatile memory, providing for increased efficiency of storage.

While the present invention has been described in connection with what are presently considered to be the most practical and preferred embodiments, it is to be understood that the present invention is not limited to these herein disclosed embodiments. Rather, the present invention is intended to cover all of the various modifications and equivalent arrangements included within the spirit and scope of the appended claims.

Although specific features of various embodiments of the invention may be shown in some drawings and not in others, this is for convenience only. In accordance with the principles of the invention, the feature(s) of one drawing may be combined with any or all of the features in any of the other drawings. The words “including”, “comprising”, “having”, and “with” as used herein are to be interpreted broadly and comprehensively and are not limited to any physical interconnection. Moreover, any embodiments disclosed herein are not to be interpreted as the only possible embodiments. Rather, modifications and other embodiments are intended to be included within the scope of the appended claims.

1. A computer program implemented method for securely transferring content sent between clients using a storage media and a computer processor, the method comprising:
receiving the content on a server array from a first node;
persisting the content in parts and distributing the content to at least two servers of the server array;
storing the content on volatile memory on a logical memory store, the logical memory store comprising at least two of the servers of the server array;
creating a unique identification for the content;
allowing retrieval of the content based on predetermined business logic, the unique identification, or both; and
resetting the volatile memory on the plurality of servers at a predetermined time after retrieval of the content to permanently erase the content, wherein resetting the volatile memory comprises setting the logic circuit gates for the servers with the distributed content to off, and then setting the logic circuit gates in those servers back to on.

2. The method of claim 1, further comprising:
generating a notification that the content is available for retrieval by a second node based on the predetermined business logic, the unique identification or both; and
receiving a content request from the second node.

3. The method of claim 1, wherein the resetting step is in response to the retrieval of the content by the second node, and is defined by the predetermined business logic residing on at least one of the plurality of servers.

4. The method of claim 1, further comprising receiving data from a non-volatile memory in communication with, but partitioned from, the server array, and associating the content with the data received from the non-volatile memory.

5. The method of claim 4, wherein the content stored in the volatile memory comprises messaging data from a user, and the data stored on the non-volatile data comprises information about the user.

6. (canceled)

7. The method of claim 1, wherein the volatile memory comprises a virtualization environment configured for:
storing, in a cluster logic shared memory store, the content residing on a plurality of servers;
storing, on each of the plurality of servers, the predetermined business logic; and
proxying a server of the server array in response to a request from the first node, second node, or both;
selecting a server from the server array in the virtualization environment to a second location of the virtualization environment; and
completing the request by contacting a metadata partition, an object partition or both.

8. The method of claim 7, further comprising distributing workloads over the virtualized environment, wherein the workloads comprise a plurality of contents.

9. The method of claim 1, wherein the array of servers are configured to prioritize content and reset of the server array based on the predetermined business logic.

10. A computer program implemented system for securely transferring content sent between clients using a storage media and a computer processor, the system comprising:
a server array capable of receiving content from a node, the server array comprising a storage medium provisioned for a logical server memory store;
a memory for storing instructions that when executed by the at least one processor cause the system to:
receive the content on a server array from a first node;
persist the content in parts and distribute the content to at least two servers of the server array;
store the content on volatile memory on a logical memory store, the logical memory store comprising at least two of the servers of the server array;
create a unique identification for the content;
allow retrieval of the content based on predetermined logic, the identification or both; and
reset the volatile memory on the plurality of servers at a predetermined time after retrieval of the content to permanently erase the content, wherein resetting the volatile memory comprises setting the logic circuit gates for the servers with the distributed content to off, and then setting the logic circuit gates in those servers back to on.

11. The system of claim 10, further comprising:
generate a notification that the content is available for retrieval by a second node based on the predetermined logic, the identification or both; and
receive a content request from the second node.

12. The system of claim 10, wherein the reset step is in response to the retrieval of the content by the second node, and is defined by predetermined business logic residing on at least one of the plurality of servers.

13. The system of claim 10, wherein the server array is further configured to receive data from a non-volatile memory in communication with, but partitioned from, the server array, and associate the content with the data received from the non-volatile memory.

14. The system of claim 13, wherein the content stored in the volatile memory comprises messaging data from a user, and the non-volatile data comprises information about the user.

15. (canceled)

16. The system of claim 10, wherein the servers of the array of servers comprise a virtualization environment configured to:
store, in a cluster logic shared memory store, the content residing on a plurality of servers;
store, on each of the plurality of servers, the predetermined business logic; and proxy a server of the server array in response to a request from the node;
select a server from the server array in the virtualization environment to a second location of the virtualization environment; and
complete the request by contacting a metadata partition, an object partition or both.

17. The system of claim 16, further comprising a load balancer in communication with the server array and configured to distribute workloads over the virtualized environment, wherein the workloads comprise a plurality of contents.

18. The system of claim 10, wherein the servers of the server array is in networked communication such the volatile memory on each of the servers comprises and forms the cluster logical memory store.

19. The system of claim 10, wherein a copy of the content is stored on another server of the server array to provide redundancy.

20. The system of claim 10, wherein the array of servers are configured to prioritize content resetting of the server array based on the business logic.
